(19) United States
(12) Patent Application Publication
(10) Pub. No.: US 2026/0247166 A1
(43) Pub. Date: Aug. 20, 2026

(54) SYSTEM AND METHOD FOR BI-SECTOR ANTENNA (BSA) DEPLOYMENT

(71) Applicant: JIO PLATFORMS LIMITED, Ahmedabad, Gujarat (IN)

(72) Inventors: Pradeep Kumar BHATNAGAR, Navi Mumbai, Maharashtra (IN); Manoj SHETTY, Mumbai, Maharashtra (IN); Dharmesh A. CHITALIYA, Thane, Maharashtra (IN); Isha SAINI, Madhya Pradesh (IN); Hanumant KADAM, Mumbai, Maharashtra (IN); Sneha VIRKAR, Mumbai, Maharashtra (IN); Neelabh KRISHNA, Gurugram, Haryana (IN); Brijesh SHAH, Gurugram, Haryana (IN); Nitesh Kumar CHOURASIA, Thane, Maharashtra (IN); Mayank TARAN, Thane, Maharashtra (IN); Aayush BHATNAGAR, Navi Mumbai, Maharashtra (IN)

(73) Assignee: JIO PLATFORMS LIMITED, Ahmedabad, Gujarat (IN)

(21) Appl. No.: 18/992,738

(22) PCT Filed: Jun. 4, 2024
(86) PCT No.: PCT/IN2024/050677

§ 371 Date: Jan. 9, 2025

(30) Foreign Application Priority Data
Jun. 30, 2023 (IN) 202321044134

(51) Int. Cl. H04W 24/02; H04W 28/02

(52) U.S. Cl. CPC H04W 24/02; H04W 28/0289

(57) ABSTRACT

The present invention discloses a system and method for automated Bi-Sector Antenna (BSA) deployment that addresses network capacity crunch issues in multiple sectors within a specific site The system receives data corresponding to the multiple sectors, and each sector consists of cells with same azimuth angle. The data includes various parameters associated with each cell, such as physical resource blocks (PRB), average RRC-connected users, IP throughput, network traffic, and other relevant parameters. Using advanced algorithms, the system determines a set of sectors where the parameters associated with at least one cell cross a predetermined threshold, indicating capacity crunch issues. Upon identification of the set of sectors, the system evaluates whether they meet a predefined set of attributes necessary for BSA deployment, and if the predefined attributes are satisfied, the system generates and transmits signals indicating the need for BSA deployment in the identified sectors.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure generally relates to the field of telecommunications. More particularly, the present disclosure relates to a system and a method for Bi-Sector Antenna (BSA) deployment for network capacity enhancement and alleviating congestion issues.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

Conventional manual process of identifying network sectors experiencing capacity crunch issues and implementing radio solutions for capacity enhancement is riddled with challenges. It is a time-consuming endeavour that is prone to errors, leading to potential delays and inaccuracies in addressing capacity issues. Despite being able to identify these sectors within the network, understanding the actual distribution of traffic patterns within each sector remains a daunting task. Users struggle to gain insight into how the traffic is distributed and utilized within each sector, hindering effective capacity planning and optimization efforts.

Furthermore, assessing infrastructure readiness visibility, or state of preparedness of the network infrastructure to handle capacity enhancements, poses a significant challenge. The lack of clear visibility into the infrastructure's readiness makes it difficult to plan and implement appropriate solutions effectively. This often results in inefficient allocation of resources and suboptimal network performance. The conventional manual approach not only consumes substantial time and effort but also leaves room for human errors, which can have detrimental effects on the overall network performance.

There is, therefore, a need to provide a system and a method that can mitigate the problems associated with the prior arts.

### SUMMARY

In an exemplary embodiment, a method for deployment of one or more antennas in a network is described. The method includes receiving, by a data receiving module, data from a plurality of cells in the network. The data includes a plurality of performance parameters associated with each cell. The method includes analysing, by an analysis module, the data to evaluate a current state of each cell. The method includes identifying, by a threshold determination module, a set of sectors by comparing each of the plurality of performance parameters with associated one or more defined threshold values respectively. The method includes determining, by a condition evaluation module, a requirement for deploying the one or more antennas by analysing each identified sector of the set of identified sectors based on a plurality of predefined attributes. The method includes transmitting, by a signal transmission module, a set of signals based on the determined requirement for the identified sector.

In an embodiment, the plurality of performance parameters includes physical resource blocks (PRB), average of radio resource control (RRC) connected users, an internet protocol (IP) throughput, sector traffic, network traffic, band traffic, performance monitoring (PM) data, a site database measurements, and user measurements.

In an embodiment, the defined threshold indicates crossing or reaching a defined limit of network bandwidth.

In an embodiment, the one or more antennas include bi-sector antennas (BSA).

In an embodiment, the plurality of predefined attributes includes a presence of bi-sector antenna in the identified sector, a presence of an installed band on the identified sector, azimuth, an average downlink (DL) PRB utilization, and a crossing of IP throughput above the defined threshold.

In an embodiment, the band is an 850 MHZ band or a 2300 MHZ band.

In another exemplary embodiment, a system for deployment of one or more antennas in a network is described. The system includes a data receiving module, an analysis module, a threshold determination module, a condition evaluation module, and a signal transmission module. The data receiving module is configured to receive data from a plurality of cells in the network. The data includes a plurality of performance parameters associated with each cell. The analysis module is configured to analyse the data to evaluate a current state of each cell of the plurality of cells. The threshold determination module is configured to identify a set of sectors by comparing each of the plurality of performance parameters with associated one or more defined threshold values respectively. The condition evaluation module is configured to determine a requirement for deploying the one or more antennas by analysing each sector of the set of identified sectors based on a plurality of predefined attributes. The signal transmission module is configured to transmit a set of signals based on the determined requirement for the identified sector.

In an embodiment, the plurality of performance parameters includes physical resource blocks (PRB), average of radio resource control (RRC) connected users, an internet protocol (IP) throughput, sector traffic, network traffic, band traffic, performance monitoring (PM) data, a site database measurements, and user measurements.

In an embodiment, the defined threshold indicates crossing or reaching a defined limit of network bandwidth.

In an embodiment, the one or more antennas include bi-sector antennas (BSA).

In an embodiment, the plurality of conditions further includes a presence of bi-sector antenna in the identified sector, a presence of an installed band on the identified sector, azimuth, an average downlink (DL) PRB utilization, and a crossing of IP throughput above the defined threshold.

In an embodiment, the band is an 850 MHZ band or a 2300 MHZ band.

The present disclosure discloses a user equipment that is configured to determine a requirement for deploying one or more antennas in a network. The user equipment includes a processor, and a computer readable storage medium storing programming instructions for execution by the processor. Under the programming instructions, the processor is configured to receive data from a plurality of cells in the network. The data includes a plurality of performance parameters associated with each cell. Under the programming instructions, the processor is configured to analyse the data to evaluate a current state of each cell. Under the programming instructions, the processor is configured to identify a set of sectors by comparing the data received corresponding to the plurality of performance parameters associated with each cell with a defined threshold respectively. Under the programming instructions, the processor is configured to determine the requirement for deploying the antennas by analysing each sector of the set of identified sectors based on a plurality of predefined attributes. Under the programming instructions, the processor is configured to transmit a set of signals based on the determined requirement for the identified sector.

### Objects of the Invention

It is an object of the present disclosure to provide a system and a method that significantly enhances efficiency and accuracy in addressing network capacity challenges., and eliminates the need for manual analysis and decision-making, saving valuable time and resources.

It is an object of the present disclosure to provide a system and a method that provides a comprehensive understanding of traffic patterns within network sectors. By leveraging geo-spatial analysis and detailed algorithms, it offers insights into how traffic is distributed and utilized within each sector, improving capacity planning and optimization.

It is an object of the present disclosure to provide a system and a method that assessing readiness of network infrastructure to handle capacity enhancements becomes easier with the proposed system, also evaluates factors such as site infrastructure, clutter, and traffic patterns to determine the viability of deploying BSA, and this enables effective planning and implementation of capacity enhancements.

It is an object of the present disclosure to provide a system and a method that significantly reduces the likelihood of errors inherent in the manual process, by relying on algorithms and standardized analysis methods, it minimizes human error and ensures more accurate decision-making.

It is an object of the present disclosure to provide a system and a method that saves considerable time and effort for network operators or planners, and a streamlined analysis process allows for quick identification of sectors requiring BSA deployment, enabling timely and proactive capacity.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture for implementing a system for deployment of one or more antennas in a network, in accordance with an embodiment of the present disclosure.

FIG. 2 illustrates an example block diagram of the system, in accordance with an embodiment of the present disclosure.

FIG. 3 illustrates an exemplary flowchart for a Bi-Sector Antenna (BSA) deployment, in accordance with an embodiment of the present disclosure.

FIG. 4 illustrates an exemplary flowchart for checking multiple factors for BSA deployment, in accordance with an embodiment of the present disclosure.

FIG. 5 illustrates exemplary steps of a method for deployment of one or more antennas in a network, in accordance with an embodiment of the present disclosure.

FIG. 6 illustrates an example computer system in which or with which the embodiments of the present disclosure may be implemented.

The foregoing shall be more apparent from the following more detailed description of the disclosure.

### LIST OF REFERENCE NUMERALS

100—Network Architecture
102-1, 102-2 . . . 102-N—Users
104-1, 104-2 . . . 104-N—User Equipments
106—Network
108—System
202—One or more processor(s)
204—Memory
206—A Plurality of Interfaces
208—Processing Engine
210—Database
212—Data Receiving Module
214—Threshold Determination Module
216—Condition Evaluation Module
218—Signal Transmission Module
220—Analysis Module
610—External Storage Device
620—Bus
630—Main Memory
640—Read Only Memory
650—Mass Storage Device
660—Communication Port
670—Processor

### DETAILED DESCRIPTION

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

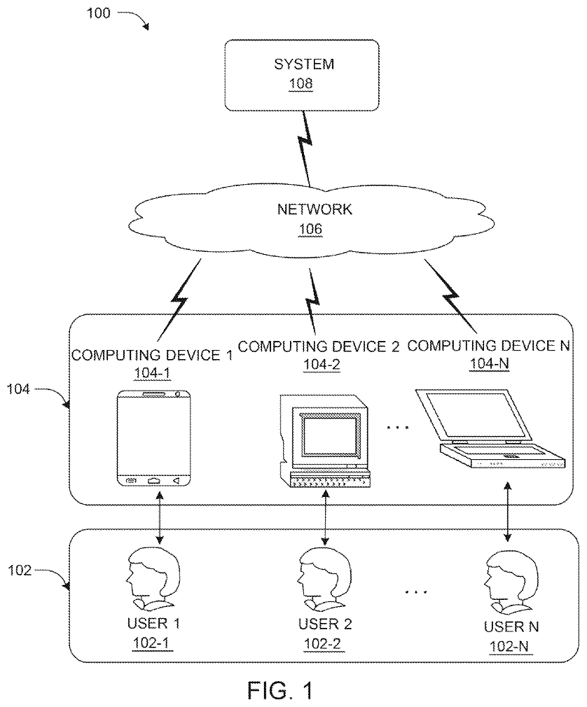

The various embodiments throughout the disclosure will be explained in more detail with reference to FIGS. 1-6.

FIG. 1 illustrates an example network architecture (100) for implementing a system (108) for deployment of one or more antennas in a network, in accordance with an embodiment of the present disclosure.

As illustrated in FIG. 1, one or more computing devices (104-1, 104-2 . . . 104-N) may be connected to the system (108) for Bi-Sector Antenna (BSA) deployment for network capacity enhancement and alleviating congestion issues. The Bi-sector antenna is made up of two directional elements that are positioned within a single physical unit. These directional elements are typically arranged in opposite directions, covering different portions of the surrounding area. Bi-sector antennas are commonly used in cell towers or base stations to provide coverage to specific areas while making the most efficient use of available frequencies and minimizing interference. By dividing the coverage area into two sectors, each sector can serve a different set of users or cover different geographic regions, which increases the overall efficiency and capacity of the network. These antennas are specifically designed to provide high gain and directivity, which allows for longer-range communication and better signal quality compared to omnidirectional antennas. These antennas are frequently used in urban and suburban areas where targeted coverage and capacity are important factors. The computing devices are connected through a network (106) to the system (108). A person of ordinary skill in the art will understand that the one or more computing devices (104-1, 104-2 . . . 104-N) may be collectively referred as computing devices (104) and individually referred as a computing device (104). One or more users (102-1, 102-2 . . . 102-N) may provide one or more requests to the system (108). A person of ordinary skill in the art will understand that the one or more users (102-1, 102-2 . . . 102-N) may be collectively referred as users (102) and individually referred as a user (102). Further, the computing devices (104) may also be referred as a user equipment (UE) (104) or as UEs (104) throughout the disclosure.

In an embodiment, the computing device (104) may include, but not be limited to, a mobile, a laptop, etc. Further, the computing device (104) may include one or more in-built or externally coupled accessories including, but not limited to, a visual aid device such as a camera, audio aid, microphone, or keyboard. Furthermore, the computing device (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the user (102) such as a touchpad, touch-enabled screen, electronic pen, and the like may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (108) is configured for automated BSA deployment in a plurality of sectors within a particular network site. The network site refers to a physical location where network infrastructure, such as antennas, base stations, and associated equipment, is deployed to provide wireless communication services. For instance, the network site is a densely populated urban area, such as a bustling city center, within this site, there are multiple sectors, which can be visualized as distinct regions or divisions within the coverage area of the telecommunications network.

In an embodiment, the system (108) is configured to receive the data from the UEs corresponding to the sectors. In an aspect, the first data may include sector traffic, internet protocol (IP) throughput, band traffic, performance monitoring (PM) data, a site database measurements, and user measurements. Each sector includes at least one cell having an azimuth angle. The azimuth angle is used to describe the orientation of antennas or sectors. Antennas are often directional, meaning they transmit and receive signals in specific directions. The azimuth angle indicates the direction in which the antenna is pointed. The data includes multiple parameters associated with each cell. For instance, a particular site is divided into sectors for efficient coverage and capacity management. Each sector represents a distinct portion of the site's coverage area, and it consists of multiple cells. These cells are responsible for providing network coverage and handling the communication needs of users within their respective areas.

The data includes various parameters associated with each cell, which could encompass physical resource blocks (PRB), average RRC-connected users, IP throughput, network traffic, and other relevant metrics. These performance parameters provide insights into the performance and usage characteristics of each cell within the sectors. By receiving and processing the data, the system can analyse the performance and capacity of each cell within the sectors. It enables the system to identify potential capacity crunch issues and determine the need for radio solutions to enhance capacity. The system leverages these parameters to evaluate the current state of each cell and make informed decisions regarding the deployment of Bi-sector Antennas (BSAs) or other appropriate measures.

In an embodiment, the system (108) is configured to determine a set of sectors where the multiple performance parameters associated with at least one cell of each sector cross a defined threshold (defined value) (or a range of values corresponding to each parameter). The system analyses these performance parameters for each cell within the sectors and assesses if they cross a predetermined threshold. The threshold is a predefined value that serves as a benchmark or reference point to identify sectors that exhibit specific characteristics or conditions. It could represent certain capacity constraints, performance limitations, or other factors deemed important for the determination of capacity crunch issues. In an aspect, these defined values are configurable and may be configured to base upon the requirements.

In an embodiment, the system (108) is configured to evaluate whether the sectors meet a plurality of predefined attributes (predefined set of conditions) for BSA deployment. Upon determining the sectors based on the analysis of parameters and threshold crossing, the system proceeds to assess whether these sectors fulfil certain conditions that make them suitable for BSA deployment. These conditions are predefined criteria that serve as guidelines or requirements for determining the feasibility of deploying BSA in specific sectors. The evaluation process involves considering various factors, such as the physical characteristics of the site, including infrastructure and clutter, as well as analyzing the traffic patterns within the surrounding area of the sector. These factors play a crucial role in determining the viability and effectiveness of deploying BSA within the identified sectors. By leveraging detailed algorithms and utilizing geo-spatial analysis, the system assesses whether the sectors meet the predefined set of conditions. This evaluation helps determine whether the deployment of BSA in these sectors is feasible and may provide the desired capacity enhancement and congestion alleviation.

The plurality of predefined attributes (predefined set of conditions) may include considerations such as available infrastructure support, compatibility with existing network components, optimal coverage and capacity improvement, minimization of interference, and other relevant factors specific to BSA deployment. By evaluating whether the sectors meet these conditions, the system provides network operators or planners with valuable insights and analysis to support decision-making regarding the implementation of BSA for addressing congestion issues in the specified frequency bands.

In an embodiment, the system (108) may be configured to transmit a set of signals indicating the need for BSA deployment in the first set of sectors upon determining that the predefined set of conditions is met. After evaluating the sectors based on the predefined set of conditions, the system determines whether these sectors fulfil the necessary requirements for BSA deployment. If the evaluation confirms that the conditions are satisfied, the system proceeds to transmit a set of signals. These signals serve as a communication mechanism to notify the relevant entities, such as network operators or planners, about the need for BSA deployment in the identified sectors. By transmitting these signals, the system effectively communicates the decision to deploy BSA and initiates the necessary actions for implementing the deployment process. The transmission of signals can be achieved through the network (106) within the telecommunications infrastructure. The signals convey the information that the first set of sectors has been identified as suitable for BSA deployment based on the evaluation of the predefined set of conditions. By transmitting these signals, the system ensures that the decision to deploy BSA is effectively communicated and enables the stakeholders to take appropriate actions.

In an exemplary implementation, the system (108) facilitates the deployment of bi-sectorization in highly congested 2300 MHz and 850 MHz primary cells. Bi-sectorization involves the deployment of Bi-sector Antennas (BSA) in primary cells as a means of alleviating congestion. The system leverages the power of geo-spatial analysis to evaluate a range of factors that influence the feasibility of bi-sector deployment. It takes into consideration the physical characteristics of the site, including its infrastructure and clutter, while also analyzing the traffic patterns within the surrounding area. Using sophisticated algorithms, the system (108) assesses whether the primary cell fulfils all the necessary requirements for the successful implementation of a bi-sector solution. In essence, the system (108) provides network operators or planners with valuable insights and analysis, assisting them in determining the viability of deploying bi-sectorization in specific primary cells based on factors such as site infrastructure, clutter, and traffic patterns. By offering these comprehensive insights, the system aids decision-making processes concerning the implementation of bi-sector antennas, thereby addressing congestion issues within the specified frequency bands.

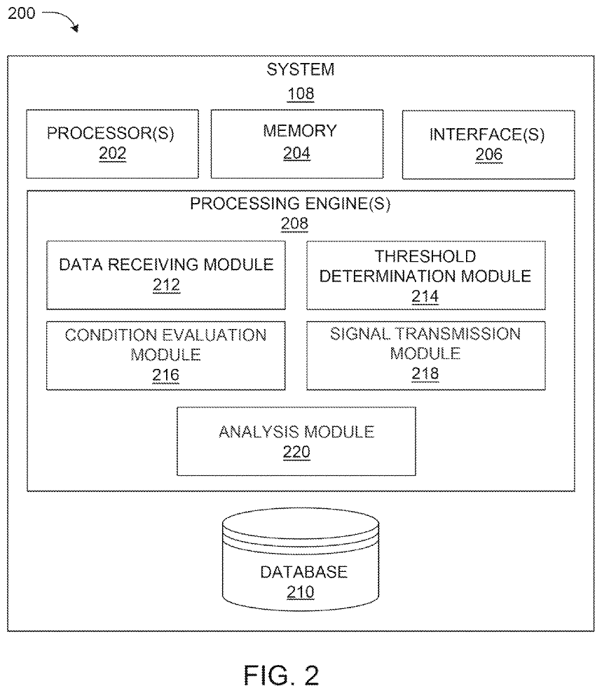

FIG. 2 illustrates an example block diagram (200) of the system (108), in accordance with an embodiment of the present disclosure.

Referring to FIG. 2, in an embodiment, the system (108) may include one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer-readable storage medium, which may be fetched and executed to create or share data packets over a network service. The memory (204) may comprise any non-transitory storage device including, for example, volatile memory such as random-access memory (RAM), or non-volatile memory such as erasable programmable read-only memory (EPROM), flash memory, and the like. The memory (204) is configured to store one or more defined threshold values corresponding to each parameter. In an aspect, the one or more defined threshold values are configurable values and can be updated by an operator.

In an embodiment, the system (108) may include an interface(s) (206). The interface(s) (206) may comprise a variety of interfaces, for example, interfaces for data input and output devices (I/O), storage devices, and the like. The interface(s) (206) may facilitate communication through the system (108). The interface(s) (206) may also provide a communication pathway for one or more components of the system (108). Examples of such components include, but are not limited to, processing engine(s) (208) and a database (210). Further, the processing engine(s) (208) may include a data receiving module (212), a threshold determination module (214), a condition evaluation module (216), a signal transmission module (218), an analysis module (220), and other engine(s). In an embodiment, the other engine(s) may include, but are not limited to, a data ingestion engine, an input/output engine, and a notification engine.

In an embodiment, the processing engine(s) (208) may be implemented as a combination of hardware and programming (for example, programmable instructions) to implement one or more functionalities of the processing engine(s) (208). In the examples described herein, such combinations of hardware and programming may be implemented in several different ways. For example, the programming for the processing engine(s) (208) may be processor-executable instructions stored on a non-transitory machine-readable storage medium, and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system may comprise the machine-readable storage medium storing the instructions and the processing resource to execute the instructions, or the machine-readable storage medium may be separate but accessible to the system and the processing resource. In other examples, the processing engine(s) (208) may be implemented by electronic circuitry.

In an embodiment, the processor (202) may be configured to receive data corresponding to a plurality of sectors by the data receiving module (212). Each sector consists of at least one cell that shares the same azimuth angle, and the data encompasses various parameters associated with each individual cell. The data receiving module is configured to receive data from a plurality of cells in the network. The data includes a plurality of performance parameters associated with each cell. The data receiving module (212) enables the processor (202) to gather and consolidate the necessary information, allowing for further analysis and processing. By receiving the data, the system gains insight into the characteristics and attributes of each cell within the sectors, forming the foundation for subsequent evaluations and decision-making processes.

The analysis module is configured to analyse the data to evaluate a current state of each cell of the plurality of cells.

The threshold determination module is configured to identify a set of sectors by comparing the data received corresponding to each of the plurality of performance parameters with associated one or more defined threshold values respectively. The set of sectors exhibits characteristics or conditions warranting further attention or action, serving as a basis for subsequent decision-making processes within the system.

For example, the plurality of performance parameters includes physical resource blocks (PRB), average of radio resource control (RRC) connected users, an internet protocol (IP) throughput, sector traffic, network traffic, band traffic, performance monitoring (PM) data, a site database measurements, and user measurements. In an aspect, the threshold determination module is configured to compare the data received corresponding to the sector traffic with one or more defined threshold values stored in the memory corresponding to the sector traffic parameter. In an example, the one or more defined threshold values include a value of X GB. If the data received corresponding to the sector traffic is greater than then the X GB, then the threshold determination module includes that sector in the set of identified sectors. In a similar way, the threshold determination module is configured to compare the data received corresponding to the IP throughput with one or more defined threshold values fetched from the memory, stored corresponding to the IP throughput parameter. In an example, the one or more defined threshold values include a value of M Kbps. For example, the M has a value of 2048. If the data received corresponding to the IP throughput is less than the M Kbps, then the threshold determination module shortlists that sector for the set of identified sectors.

The threshold determination module is configured to compare the data received corresponding to the brand traffic with one or more defined threshold values fetched from the memory, stored corresponding to the brand traffic parameter. In an example, the one or more defined threshold values include a value of Y GB. If the data received corresponding to the brand traffic is less than the Y GB, then the threshold determination module shortlists that sector for the set of identified sectors.

In an embodiment, the processor (202) may be configured to determine the set of sectors, by the threshold determination module (214). This determination is based on the analysis of parameters associated with at least one cell within each sector, specifically considering whether these parameters cross a predetermined threshold. The threshold determination module (214) allows the processor (202) to compare the values of the parameters against the established threshold (defined threshold), identifying the sectors in which the parameter values surpass the threshold. For example, the defined threshold indicates crossing or reaching a defined limit of network bandwidth.

By performing this evaluation, the system can effectively identify the sectors that exhibit characteristics or conditions warranting further attention or action, serving as a basis for subsequent decision-making processes within the system.

The condition evaluation module is configured to determine a requirement for deploying the one or more antennas by analysing each sector of the set of identified sectors based on the plurality of predefined attributes. In an embodiment, the plurality of conditions further includes a presence of bi-sector antenna in the identified sector, a presence of an installed band on the identified sector, azimuth, an average downlink (DL) PRB utilization, and a crossing of IP throughput above the defined threshold.

In an embodiment, the processor (202) may be configured to evaluate, by the condition evaluation module (216) whether the first set of sectors meets a predefined set of conditions for BSA deployment. The condition evaluation module (216) enables the processor (202) to analyse the characteristics and attributes of the sectors within the first set of sectors, comparing them against the predefined conditions. By conducting this evaluation, the system can determine if the sectors meet the necessary criteria for deploying BSA solutions. This assessment ensures that the selected sectors possess the required infrastructure, traffic patterns, or other essential factors that align with the predefined conditions, enabling effective decision-making and deployment strategies for BSA technology.

The signal transmission module is configured to transmit a set of signals based on the determined requirement for the identified sector. In an embodiment, the processor (202) may be configured to transmit the set of signals, by the signal transmission module (218). The set of signals indicates a need for BSA deployment in the first set of sectors upon determining that the predefined set of conditions is met. The signal transmission module (218) enables the processor (202) to communicate this crucial information to the relevant stakeholders or systems responsible for deploying BSA solutions. By transmitting these signals, the system effectively conveys the need for BSA deployment in the selected sectors, ensuring that the appropriate actions can be taken promptly and efficiently based on the determined conditions.

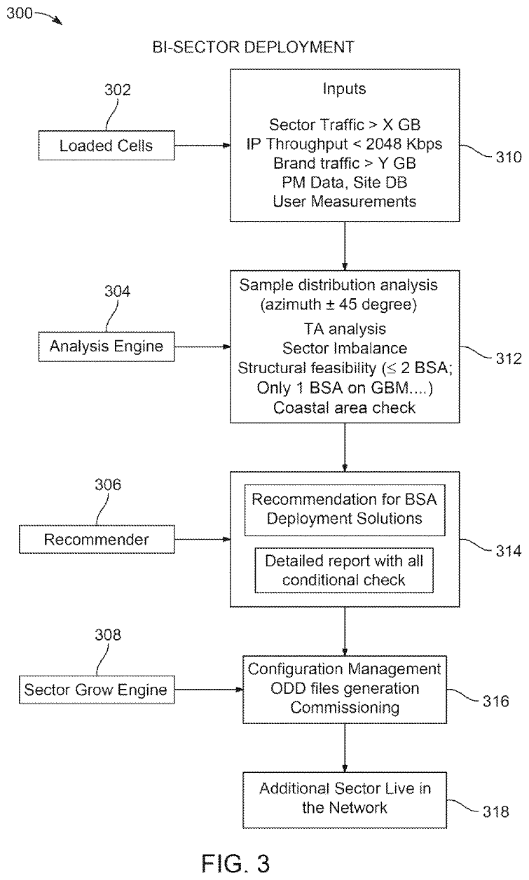

FIG. 3 illustrates an exemplary flowchart (300) for BSA deployment, in accordance with an embodiment of the present disclosure.

As illustrated, a flowchart (300) disclosing working of Bi-sector deployment solution being disclosed, for faster deployment, and ensures congestion alleviation through proper offload. Also provides recommendations for BSA deployment with detailed report.

At step (302), a plurality of cells is loaded. The plurality of cells is loaded with a plurality of inputs (310). The plurality of inputs comprises sector traffic >X GB, IP throughput <M Kbps (e.g., 2048 Kbps), Brand traffic >Y GB, PM data, site DB, and user measurements. The user measurements are measurement of parameters from the user side. The user measurements are based on crowd sourced usage data measured for each of users connected in the network.

At step (304), an analysis engine (analysis module) performs an analysis of the inputs. The analysis (312) may include sample distribution analysis (azimuth +−45 degree), target area (TA) analysis. Sector imbalance structural feasibility (<−2BSA; only 1 BSA on ground-based mast (GBM)), and coastal area check.

At step (306), a recommender provides recommendations for BSA deployment solutions. A detailed report with all conditional check (314) is provided to a network operator.

At step (308), a sector grow engine may perform configuration management, odd files generation, commissioning (316).

At step (318), checking additional sector live in the network.

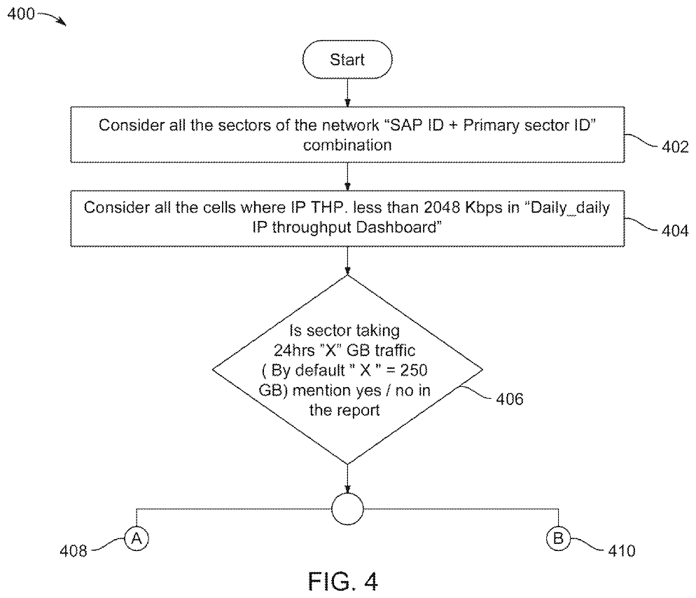

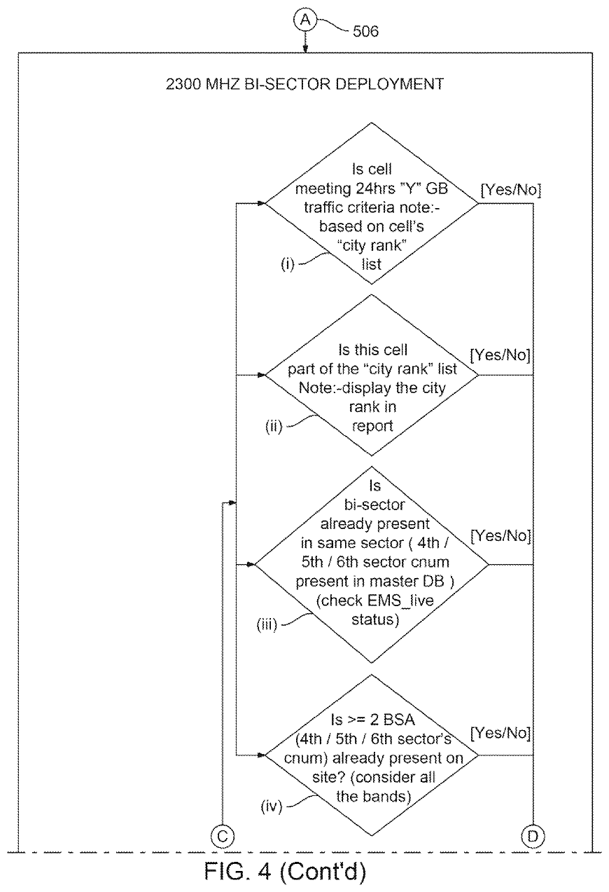

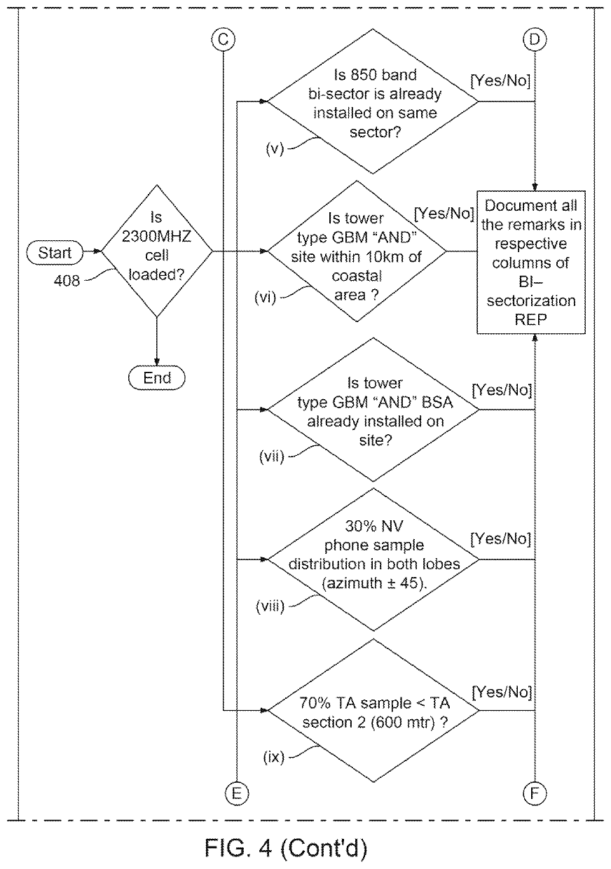

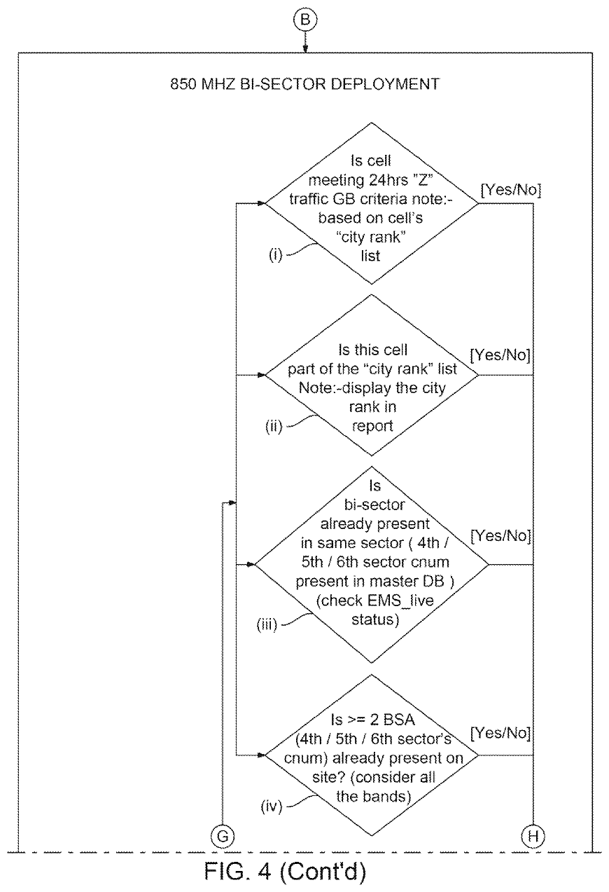

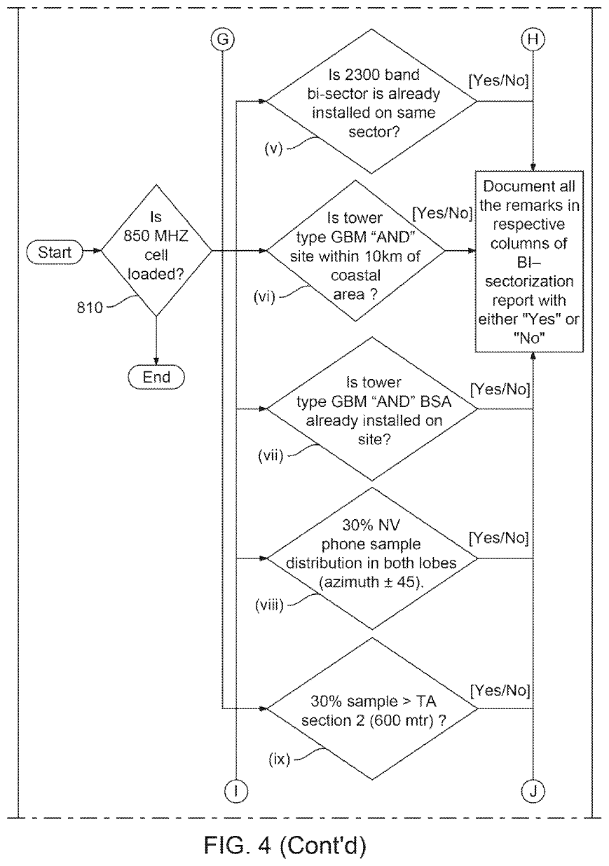

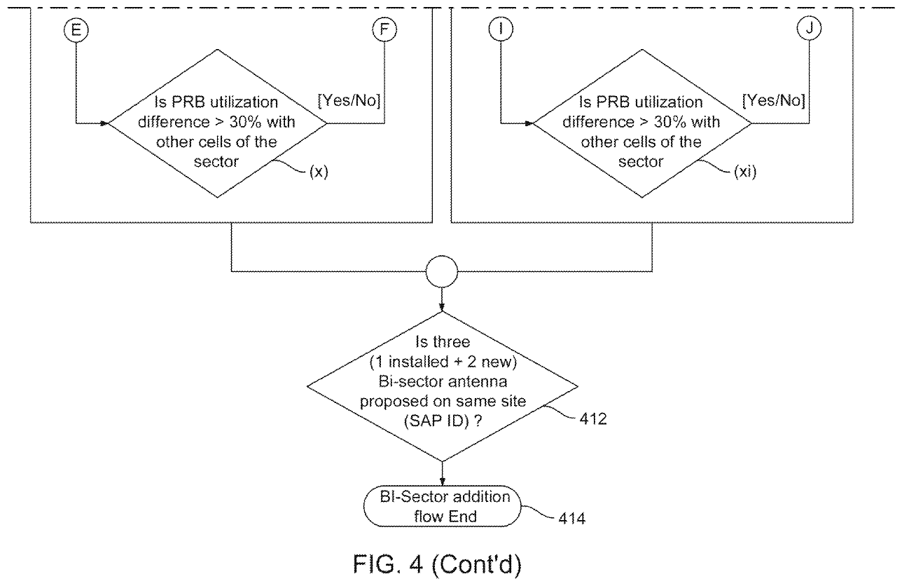

FIG. 4 illustrates an exemplary flowchart (400) for checking multiple factors for BSA deployment, in accordance with an embodiment of the present disclosure.

As illustrated, a flowchart (400) comprises: at step (402), by considering all sectors of network “SAP ID+Primary Sector ID” combination. The service access point (SAP) ID is an identifying label for the sectors. In an aspect, an SAP is systems applications and products in data processing. The SAP is used to control all types of critical functions. By integrating and automating key processes, the SAP helps in faster and more efficient processing of functions. The SAP ID corresponds to the identifier for the SAP.

At step (404), the system considers all cells where IP Throughput is less than M Kbps (e.g., 2048 Kbps) in “Daily_Daily IP Throughput Dashboard”. The system checks cell presents in “Daily_Daily IP Throughput less than M Kbps (e.g., 2048Kbps)” Report, and accordingly use D-1 or Latest available data.

At step (406), the system checks whether sector (considering all the cells of the same sector) taking a predefined time interval (e.g., 24 Hrs) “X” GB Traffic (By default “X”=250 GB), and correspondingly mention Yes or No in the Report.

At step (408) for 2300 MHz Bi-Sector Deployment Task, the system checks if 2300 MHz cell is loaded, if the determination is yes, proceed further to check,
(i) cell meeting the predefined time interval (e.g., 24 Hrs) “Y” GB Traffic criteria (Based on Cell's “City Rank” list),
(ii) cell part of the “City Rank” list (Display CITY RANK in the report), refer “CITY RANK” column of CP Master DB,
(iii) Bi-Sector already present in the same sector (4th/5th/6th Sector Cnum present in Master DB) (Check EMS_LIVE Status)—check if sector under consideration has Cnum mentioned below: Sector Alpha: cNUM20, Sector Beta: cNUM18, Sector Gamma: cNUM19, and Final Value is as per cNum Mapping Sheet
(iv) is >=2 BSA (4th/5th/6th Sector's Cnum) Already present on site? (consider all the bands), based on determination yes or no for all steps, update Bi—Sectorization Report.
(v) if 850 Band Bi-Sector is already installed on same sector (check if 850M Bi-Sector Cnum is present in Master DB?),
(vi) if Tower Type GBM “AND” Site within a predefined distance (e.g., 10 Km) of a coastal area, and
(vii) if Tower Type GBM “AND” BSA already installed on site, based on determination yes or no for all steps, update Bi-Sectorization Report.

Further, the system checks
(viii) if 30% NV+Phone sample distribution in both Lobes (Azimuth ±45) (30% of NV+Phone samples must be distributed across ±45 degree of Cell's Azimuth out of total sample of 2300 C1 & C2 cells.),
(ix) if 70% TA sample<TA Section 2 (600 Mtr), and
(x) if PRB Utilization difference >30% with other cells of the sector, based on determination yes or no for all steps, update Bi—Sectorization Report.

At step 410, For the 850 MHz Bi-Sector Deployment Task, the system checks if the 800 MHz cell is loaded, if the determination is yes, proceed further to check,
(i) cell meeting the predefined time interval (e.g., 24 Hrs) “Z” GB Traffic criteria (Based on Cell's “City Rank” list),
(ii) cell part of the “City Rank” list (Display CITY RANK in the report), refer “CITY RANK” column of the CP Master DB,
(iii) Bi-Sector already present in the same sector (4th/5th/6th Sector Cnum present in Master DB) (Check EMS_LIVE Status)—check if sector under consideration has Cnum mentioned below: Sector Alpha: cNUM20, Sector Beta: cNUM18, Sector Gamma: cNUM19, and Final Value is as per cNum Mapping Sheet
(iv) is >=2 BSA (4th/5th/6th Sector's Cnum) Already present on site? (consider all the bands), based on determination yes or no for all steps, update Bi—Sectorization Report.

Also, the system checks
(v) if 850 Band Bi-Sector is already installed in the same sector (check if 850M Bi-Sector Cnum is present in Master DB?),
(vi) if Tower Type GBM “AND” Site within the predefined distance (e.g., 10 Km) of coastal area, and
(vii) if Tower Type GBM “AND” BSA already installed on site, based on determination yes or no for all steps, update Bi—Sectorization Report.

Further, the system check
(viii) if 30% NV+Phone sample distribution in both Lobes (Azimuth ±45) (30% of NV+Phone samples must be distributed across ±45 degree of Cell's Azimuth out of total sample of 2300 C1 & C2 cells.),
(ix) if 70% TA sample<TA Section 2 (600 Mtr), and
(x) if PRB Utilization difference >30% with other cells of the sector, based on determination yes or no for all steps, update Bi—Sectorization Report.

At step 412, Finally, check if three (1 installed+2 new) Bi-Sector antenna proposed on same site (SAP ID).

At step 414, Bi-sector addition is performed.

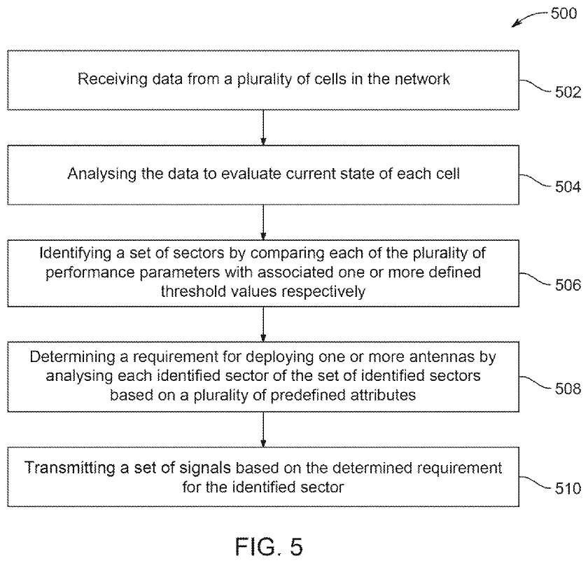

FIG. 5 illustrates exemplary steps of a method (500) for deployment of one or more antennas in a network, in accordance with an embodiment of the present disclosure.

At step 502, the system is configured to receive data from a plurality of cells in the network. The data includes a plurality of performance parameters associated with each cell of the plurality of cells. In an embodiment, the plurality of performance parameters includes physical resource blocks (PRB), average of radio resource control (RRC) connected users, an internet protocol (IP) throughput, sector traffic, network traffic, band traffic, performance monitoring (PM) data, a site database measurements, and user measurements.

At step 504, the system is configured to analyse the data to evaluate current state of each cell.

At step 506, the system is configured to identify a set of sectors by comparing each of the plurality of performance parameters with associated one or more defined threshold values respectively. The system is configured to check whether the plurality of performance parameters associated with at least one cell of each identified sector of the set of sectors crosses a defined threshold or not.

At step 508, the system is configured to determine a requirement for deploying the one or more antennas by analysing each identified sector. The system is configured to analyse the set of sectors based on a plurality of predefined attributes. The plurality of predefined attributes includes physical characteristics of site, infrastructure and clutter, traffic patterns within the surrounding area. In an embodiment, the plurality of predefined attributes includes a presence of bi-sector antenna in the identified sector, a presence of an installed band on the identified sector, azimuth, an average downlink (DL) PRB utilization, and a crossing of IP throughput above the defined threshold. Further, the system is configured to analyse the set of sectors based upon a plurality of predefined conditions. The plurality of predefined conditions comprise, for example, whether the sector is taking ‘X’ GB traffic or whether the cell is meeting ‘Y’ GB traffic. Is bisector already present in the cell?, Is tower type ground based monopole (GBM)?, Is site within defined KM of the coastal area?, Is defined band bisector already installed on the same sector?, Is tower type GBM and Bisector already installed on the site?, Is PRB utilization difference >predefined percentage with other cells of the sector.

The plurality of predefined condition comprises for example, checking whether sector taking “X” GB (e.g., X=250 GB) traffic.

For example, checking whether tower type is ground based monopole (GBM). Further, checking whether the site is within defined area (e.g., within 10 KMs of coastal area.

For example, the system is configured to check whether a Bi-sector antenna (BSA) is already installed on the site.

For example, the system is configured to check whether a 2300 MHZ or 800 MHz cell is loaded. At step 508, the system is configured to determine one sector from the set of sectors for deploying the antennas. The identified sector meets the plurality of predefined conditions. The method includes transmitting, by a signal transmission module, a set of signals.

At step 510, the system is configured to transmit a set of signals based on the determined requirement for the identified sector. The set of signals indicates a need for antenna deployment in the identified sector.

In an exemplary aspect, the present disclosure discloses a user equipment that is configured to determine a requirement for deploying one or more antennas in a network. The user equipment includes a processor, and a computer readable storage medium storing programming instructions for execution by the processor. Under the programming instructions, the processor is configured to receive data from a plurality of cells in the network. The data includes a plurality of performance parameters associated with each cell. Under the programming instructions, the processor is configured to analyse the data to evaluate a current state of each cell. Under the programming instructions, the processor is configured to identify a set of sectors by comparing each of the plurality of performance parameters with associated one or more defined threshold values respectively. Under the programming instructions, the processor is configured to determine a requirement for deploying the antennas by analysing each sector of the set of identified sectors based on a plurality of predefined attributes Under the programming instructions, the processor is configured to transmit a set of signals based on the determined requirement for the identified sector.

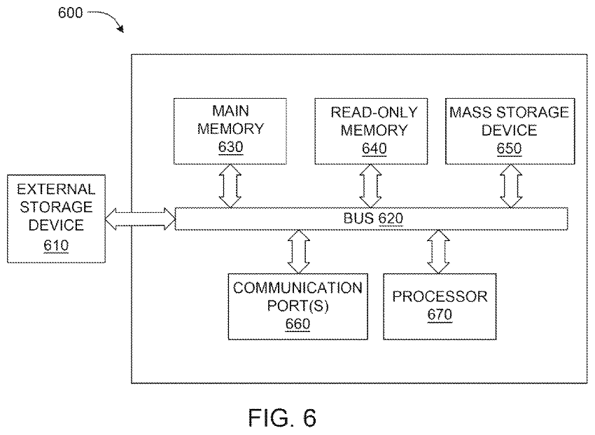

FIG. 6 illustrates an example computer system (600) in which or with which the embodiments of the present disclosure may be implemented.

As shown in FIG. 6, the computer system (600) may include an external storage device (610), a bus (620), a main memory (630), a read-only memory (640), a mass storage device (650), a communication port(s) (660), and a processor (670). A person skilled in the art will appreciate that the computer system (600) may include more than one processor and communication ports. The processor (670) may include various modules associated with embodiments of the present disclosure. The communication port(s) (660) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (660) may be chosen depending on a network, such as a Local Area Network (LAN), Wide Area Network (WAN), or any network to which the computer system connects.

In an embodiment, the main memory (630) may be Random Access Memory (RAM), or any other dynamic storage device commonly known in the art. The read-only memory (640) may be any static storage device(s) e.g., but not limited to, a Programmable Read Only Memory (PROM) chip for storing static information e.g., start-up or basic input/output system (BIOS) instructions for the processor (670). The mass storage device (650) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (620) may communicatively couple the processor(s) (670) with the other memory, storage, and communication blocks. The bus (620) may be, e.g. a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (670) to the computer system (600).

In another embodiment, operator and administrative interfaces, e.g., a display, keyboard, and cursor control device may also be coupled to the bus (620) to support direct operator interaction with the computer system (600). Other operator and administrative interfaces can be provided through network connections connected through the communication port(s) (660). Components described above are meant only to exemplify various possibilities. In no way should the aforementioned exemplary computer system (600) limit the scope of the present disclosure.

Various above disclosed embodiments of the proposed system and method provide efficient and accurate solutions for network capacity challenges, offering comprehensive insights into traffic patterns, simplifying infrastructure readiness assessment, reducing errors, and saving time and effort for network operators.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method that offer substantial improvements in efficiency and accuracy when addressing network capacity challenges, and by eliminating need for manual analysis and decision-making, valuable time and resources are saved.

The present disclosure provides a system and a method that enhance understanding of traffic patterns within network sectors, through utilization of geo-spatial analysis and detailed algorithms, the system provides valuable insights into the distribution and utilization of traffic in each sector, leading to improved capacity planning and optimization.

The present disclosure provides a system and a method that simplifies assessment of network infrastructure readiness for capacity enhancements and evaluates factors such as site infrastructure, clutter, and traffic patterns to determine the feasibility of deploying BSA, enabling effective planning and implementation of capacity enhancements.

The present disclosure provides a system and a method that significantly reduces likelihood of errors inherent in manual processes. This ensures more accurate decision-making, minimizing human error and improving overall reliability.

The present disclosure provides a system and a method that save significant time and effort for network operators or planners, and streamlined analysis process enables the swift identification of sectors requiring BSA deployment, facilitating timely and proactive capacity enhancements.

1. A method for deployment of one or more antennas in a network, the method comprising:
receiving, by a data receiving module, data from a plurality of cells in the network, wherein the data includes a plurality of performance parameters associated with each cell of the plurality of cells;
analysing, by an analysis module, the data to evaluate a current state of each cell of the plurality of cells;
identifying, by a threshold determination module, a set of sectors by comparing each of the plurality of performance parameters with associated one or more defined threshold values respectively;
determining, by a condition evaluation module, a requirement for deploying the one or more antennas by analysing each identified sector of the set of identified sectors based on a plurality of predefined attributes; and
transmitting, by a signal transmission module, a set of signals based on the determined requirement for each identified sector.

2. The method as claimed in claim 1, wherein the plurality of performance parameters includes physical resource blocks (PRBs), an average of radio resource control (RRC) connected users, an internet protocol (IP) throughput, sector traffic, network traffic, band traffic, performance monitoring (PM) data, site database measurements, and user measurements.

3. The method as claimed in claim 1, wherein the associated one or more defined threshold values indicate crossing or reaching a defined limit of network bandwidth.

4. The method as claimed in claim 1, wherein the one or more antennas include bi-sector antennas (BSAs).

5. The method as claimed in claim 1, wherein the plurality of predefined attributes includes a presence of a BSA in each identified sector, a presence of an installed band on each identified sector, azimuth, an average downlink (DL) PRBs utilization, and a crossing of IP throughput above a defined threshold.

6. The method as claimed in claim 1, wherein the installed band is an 850 megahertz (MHZ) band or a 2300 MHZ band.

7. A system for deployment of one or more antennas in a network comprising:
a data receiving module configured to receive data from a plurality of cells in the network, wherein the data includes a plurality of performance parameters associated with each cell of the plurality of cells;
an analysis module configured to analyse the data to evaluate a current state of each cell of the plurality of cells;
a threshold determination module configured to identify a set of sectors by comparing each of the plurality of performance parameters with associated one or more defined threshold values respectively;
a condition evaluation module configured to determine a requirement for deploying the one or more antennas by analysing each identified sector of the set of identified sectors based on a plurality of predefined attributes; and
a signal transmission module configured to transmit a set of signals based on the determined requirement for each identified sector.

8. The system as claimed in claim 7, wherein the plurality of performance parameters includes physical resource blocks (PRBs), an average of radio resource control (RRC) connected users, an internet protocol (IP) throughput, sector traffic, network traffic, band traffic, performance monitoring (PM) data, site database measurements, and user measurements.

9. The system as claimed in claim 7, wherein the one or more defined threshold values indicate crossing or reaching a defined limit of network bandwidth.

10. The system as claimed in claim 7, wherein the one or more antennas include bi-sector antennas (BSAs).

11. The system as claimed in claim 7, wherein the plurality of predefined attributes further includes a presence of a BSA in each identified sector, a presence of an installed band on each identified sector, azimuth, an average downlink (DL) PRBs utilization, and a crossing of IP throughput above a defined threshold.

12. The system as claimed in claim 7, wherein the installed band is an 850 megahertz (MHZ) band or a 2300 MHZ band.

13. (canceled)

14. A computer program product comprising a non-transitory computer-readable medium comprising instructions that, when executed by one or more processors, cause the one or more processors to:
receive data from a plurality of cells in the network, wherein the data includes a plurality of performance parameters associated with each cell of the plurality of cells;
analyse the data to evaluate a current state of each cell of the plurality of cells;
identify a set of sectors by comparing each of the plurality of performance parameters with associated one or more defined threshold values respectively;
determine a requirement for deploying the one or more antennas by analysing each identified sector of the set of identified sectors based on a plurality of predefined attributes; and
transmit a set of signals based on the determined requirement for each identified sector.
